(19) United States
(12) Patent Application Publication
(10) Pub. No.: US 2016/0189064 A1
(43) Pub. Date: Jun. 30, 2016

(54) METHOD AND APPARATUS FOR PROVIDING SEAT INFORMATION

(71) Applicant: Alibaba Group Holding Limited, George Town, KY (US)

(72) Inventor: Xin MAO, Hangzhou (CN)

(21) Appl. No.: 14/975,065

(22) Filed: Dec. 18, 2015

(30) Foreign Application Priority Data
Dec. 26, 2014 (CN) 201410832171.0

(51) Int. Cl. G06Q 10/02; G06Q 30/06

(52) U.S. Cl. CPC G06Q 10/02; G06Q 30/0631

(57) ABSTRACT

Embodiments include a method and apparatus for providing seat information. The method comprises: receiving, by a server, a request uploaded by a client for reserving a seat at a current location; inquiring into a preset seat information database and determining priority information corresponding to remaining seats at the current location; the seat information database being established according to selection sequence information of each seat in a seat selection history record each time the seat is selected, with information of each seat at the current location and corresponding priority information being stored in the seat information database; determining information of a to-be-recommended seat from the remaining seats at the current location according to the priority information corresponding to the remaining seats; and returning the information of the to-be-recommended seat to the client. Using this method, better-positioned seats from among the remaining vacant seats may be quickly and accurately provided to users, thus increasing the efficiency of seat reservation.

### CROSS-REFERENCE TO RELATED APPLICATION

This application claims priority to and the benefit of Chinese Patent Application No. 201410832171.0, filed on Dec. 26, 2014, which is incorporated herein by reference in its entirety.

### FIELD

Embodiments relate to the technical field of information service applications and, in particular, to providing seat information.

### BACKGROUND

With the constant improvement of people's living standards, various entertainment activities have become an indispensable part of people's daily lives. At the same time, with the advancement of manufacturing techniques and the reduction of the manufacturing cost of electronic terminal products, various electronic terminal products have gained unprecedented popularity. The development of electronic terminal products is trending toward diversity, and such increasingly diversified electronic terminal products play an important role in many aspects of people's daily lives. In people's daily lives, they may often be involved in a variety of activities involving selecting seats in advance, for example, going to the cinema to watch movies, going to theaters to enjoy operas or dramas, going to watch various live games or matches, and the like. With assistance from some electronic terminal device products, users generally select seats or reserve tickets via applications installed on the terminal devices to enjoy such entertainment activities.

When the users reserve seats with the assistance of the applications installed on the terminal devices, the following procedures are generally involved: first, entering a ticket reservation application on a terminal device, selecting a program session to watch, selecting a venue (e.g., selecting the serial number of the projection hall), then selecting a seat in the venue, and, finally, paying for the ticket and taking the ticket. In various venues, whether a seat is good or poor may be determined according to the size of the screen, the position and volume of the loudspeaker, the gap between two rows, and the like factors. The visual effects at different seats in the venue are generally different. In the traditional mode of processing, since the user cannot predict the best seat out of the remaining vacant seats at an unfamiliar location, the user may only select a seat according to his or her own experience. As a result, the user may tend to miss the best seat in the venue. Additionally, if no satisfactory seat is found in the current venue, the user may only return to the previous step to select the session, venue, and the like. As a result, the user's time is wasted.

### SUMMARY OF THE INVENTION

Accordingly, the technical problem to be solved is how to provide a method for providing seat information which can more effectively provide best seat information in a venue for users such that the users can select their desired seats and save operating time.

Embodiments include a method and apparatus for providing seat information which may quickly and accurately provide better seats out of the remaining seats for users, thereby improving the efficiency of the seat reservation process.

Embodiments provide the following technical solutions:

In an embodiment, a method for providing seat information comprises: receiving, by a server, a request uploaded by a client for reserving a seat at a current location; inquiring into a preset seat information database, and determining priority information corresponding to remaining seats at the current location, where the seat information database is established according to selection sequence information of each seat in a seat selection history record each time the seat is selected, and where information of each seat at the current location and corresponding priority information is stored in the seat information database; determining information of a to-be-recommended seat from the remaining seats at the current location according to the priority information corresponding to the remaining seats; and returning the information of the to-be-recommended seat to the client.

In an embodiment, a method for providing seat information comprises: sending, by a client to a server, a request for reserving a seat at a current location so as to query a preset seat information database, determine priority information corresponding to remaining seats at the current location, determine information of a to-be-recommended seat from the remaining seats at the current location according to the priority information corresponding to the remaining seats, and return the information of the to-be-recommended seat to the client; where the seat information database is established according to selection sequence information of each seat in a seat selection history record each time the seat is selected, and where information of each seat at the current location and corresponding priority information is stored in the seat information database; and performing a seat recommendation according to the returned information of the to-be-recommended seat.

In an embodiment, a method for providing seat information comprises: downloading in advance, by a client, a seat information database of a designated location from a server, and locally storing the database on a terminal device; inquiring into the seat information database locally stored on the terminal device when a request for reserving a seat at the designated location is received, and determining priority information of each seat at the designated location; where the seat information database is established according to selection sequence information of each seat in a seat selection history record each time the seat is selected, and where information of each seat at the designated location and corresponding priority information is stored in the seat information database; determining information of a to-be-recommended seat from remaining seats at the currently designated location according to priority information corresponding to the remaining seats; and performing seat recommendation according to the information of the to-be-recommended seat.

In an embodiment, a method for establishing a seat information database comprises: collecting a seat selection history record at a target location, and determining, according to the history record, selection sequence information of each seat at the target location each time the seat is selected; determining, according to the selection sequence information of each seat at the target location each time the seat is selected, a corresponding priority score of each seat each time the seat is selected, gathering the corresponding priority scores of the same seat each time the seat is selected, and determining priority information of each seat at the target location; and storing seat information of each seat at the target location and the priority information corresponding to each seat as items of the seat information database.

In an embodiment, an apparatus for providing seat information comprises: a reservation request receiving unit configured to receive a request uploaded by a client for reserving a seat at a current location; a priority determining unit configured to query a preset seat information database, and determine priority information corresponding to remaining seats at the current location, where the seat information database is established according to selection sequence information of each seat in a seat selection history record each time the seat is selected, and where information of each seat at the current location and corresponding priority information is stored in the seat information database; a to-be-recommended seat determining unit configured to determine information of a to-be-recommended seat from the remaining seats at the current location according to the priority information corresponding to the remaining seats; and a seat information returning unit configured to return the information of the to-be-recommended seat to the client.

In an embodiment, an apparatus for providing seat information comprises: a reservation request sending unit configured to send a request for reserving a seat at a current location from a client to a server so as to query a preset seat information database, determine priority information corresponding to remaining seats at the current location, determine information of a to-be-recommended seat from the remaining seats at the current location according to the priority information corresponding to the remaining seats, and return the information of the to-be-recommended seat to the client, where the seat information database is established according to selection sequence information of each seat in a seat selection history record each time the seat is selected, and where information of each seat at the current location and corresponding priority information is stored in the seat information database; and a seat recommending unit configured to perform seat recommendation according to the returned information of the to-be-recommended seat.

In an embodiment, a computer-readable medium having stored thereon, computer-executable instructions that, if executed by a processor, cause the processor to perform a method comprising: sending a request for reserving a seat at a current location from a client to a server so as to query a preset seat information database, determine priority information corresponding to remaining seats at the current location, determine information of a to-be-recommended seat from the remaining seats at the current location according to the priority information corresponding to the remaining seats, and return the information of the to-be-recommended seat to the client, where the seat information database is established according to selection sequence information of each seat in a seat selection history record each time the seat is selected, and where information of each seat at the current location and corresponding priority information is stored in the seat information database; and presenting a seat recommendation according to the returned information of the to-be-recommended seat.

In an embodiment, an apparatus for providing seat information comprises: a database downloading unit configured to download in advance a seat information database of a designated location from a server, and locally store the database on a terminal device; a priority inquiring unit, configured to query the seat information database locally stored on the terminal device when a request for reserving a seat at the designated location is received, and determine priority information of each seat at the designated location; the seat information database is established according to selection sequence information of each seat in a seat selection history record each time the seat is selected, and information of each seat at the designated location and corresponding priority information is stored in the seat information database; a preferred seat determining unit configured to determine information of a to-be-recommended seat from a plurality of remaining seats at the currently designated location according to the priority information corresponding to the plurality of remaining seats; and a recommendation information calling unit configured to perform seat recommendation according to the information of the to-be-recommended seat.

In an embodiment, an apparatus for establishing a seat information database comprises: a seat selection information collecting unit, configured to collect a seat selection history record at a target location, and determining, according to the history record, selection sequence information of each seat at the target location each time the seat is selected; a priority determining unit configured to determine, according to the selection sequence information of each seat at the target location each time the seat is selected, a corresponding priority score of each seat each time the seat is selected, gather the corresponding priority scores of the same seat each time the seat is selected, and determine priority information of each seat at the target location; and a database storing unit configured to store seat information of each seat at the target location and the priority information corresponding to each seat as items of the seat information database.

Embodiments may further disclose the following technical effects:

According to the embodiments, after a server receives a request for reserving a seat at a current location, a seat information database is queried, information of a to-be-recommended seat is determined from the remaining vacant seats at the current location according to priority information of each seat at the current location that is stored in the seat information database, and then the information of the to-be-recommended seat is returned to a client, where the seat information database is established according to selection sequence information of each seat in a seat selection history record each time when the seat is selected, which may more accurately reflect good and poor seats at the current location. In this way, when the users reserve seats at the current location via the client, the seats which are better in position of the remaining seats may be quickly and accurately provided for the users. This avoids the case where the users may only select seats according to their experience and subjective judgment but making it difficult to select better seats, and in the meantime saves the operation time elapsed when the users select seats and improves the efficiency of seat reservation.

Nevertheless, it is not necessary that any embodiment achieve all of the above technical effects.

### BRIEF DESCRIPTION OF THE DRAWINGS

The accompanying drawings, which are incorporated in and form a part of this specification, and in which like numerals depict like elements, illustrate embodiments of the present disclosure and, together with the description, serve to explain the principles of the disclosure.

FIG. 1 is a flowchart of a method for establishing a seat information database according to an embodiment.

FIG. 2 is a flowchart of a method for providing seat information according to an embodiment.

FIG. 3 is a flowchart of another method for providing seat information according to an embodiment.

FIG. 4 is a flowchart of still another method for providing seat information according to an embodiment.

FIG. 5 is a diagram of a first apparatus according to an embodiment.

FIG. 6 is a diagram of a second apparatus according to an embodiment.

FIG. 7 is a diagram of a third apparatus according to an embodiment.

FIG. 8 is a diagram of a fourth apparatus according to an embodiment.

FIG. 9 is a block diagram of an example of a computing device 910 capable of implementing embodiments according to the present disclosure.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

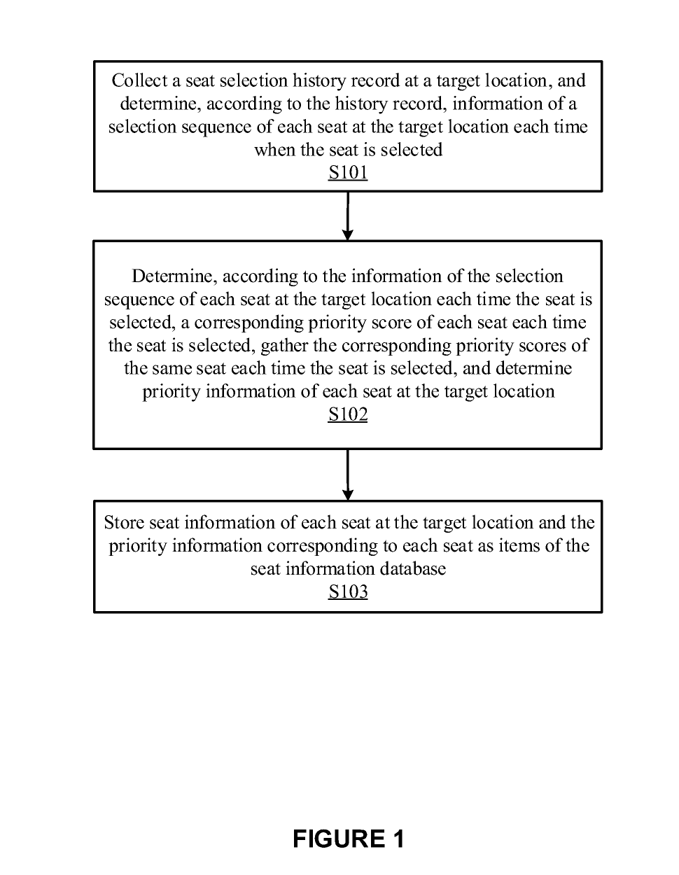

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “collecting,” “determining,” “downloading,” “gathering,” “performing,” “querying,” “receiving,” “reserving,” “returning,” “sending,” “storing,” or the like, refer to actions and processes (e.g., the flowcharts of FIGS. 1-4) of a computer system or similar electronic computing device or processor (the computing device 910 of FIG. 1). A computer system or similar electronic computing device manipulates and transforms data represented as physical (electronic) quantities within the computer system memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared and other wireless media. Combinations of any of the above can also be included within the scope of computer-readable media.

In real life, by means of an application installed on a terminal device, a user may reserve tickets such as movie tickets, tickets for shows or matches, and the like. During the process of reserving tickets via a client application, selection of seats may also be implemented. However, with respect to different locations, the best watching positions are generally different positions at the location. For example, in a movie projection hall, due to differences in the arrangement of the seats, the gap between two rows, the position of the screen/loudspeaker and the like factors, the best seats for watching in different movie projection halls are generally different. In addition to the best seats for watching, the remaining vacant seats at the same location are also different in terms of properties and desirability. Since they have no in-person physical reference, most users cannot judge and select the best seats for watching from the remaining vacant seats at the unfamiliar location by means of the interface of the application. To more effectively and accurately provide the best seats for watching at different locations, in an embodiment, a method for establishing a seat information database is provided. According to the method, data of seat selections made by a specific number of users is collected for statistical analysis and, thus, position priorities of different seats at different locations may be accurately determined, and the priority information may be stored in a seat information database in the form of computer data. Hence, when the user initiates a request for reserving a seat at a target location via a client, the user may determine the best seats in terms of position at the target location by querying the seat information database and, thus, information regarding the best seats out of the remaining vacant seats is proactively and quickly provided to the user. In this way, the efficiency of providing seat information to the user is improved. Hereinafter, various embodiments are described in detail.

An embodiment includes a method for establishing a seat information database. As illustrated in FIG. 1, a flowchart of a method for establishing a seat information database according to an embodiment is given. The method may comprise the following steps.

In step S101, a seat selection history record at a target location is collected, and selection sequence information for each seat at the target location is determined according to the history record each time the seat is selected.

To ensure that the data in the seat information database is capable of correctly and objectively reflecting the priority information of each seat at the target location, first, data in a specific quantity may be statistically collected. The collected data may be history selection records of the seats at the target location. According to the history selection records of the seats, selection sequence information of each seat at the target location each time the seat is selected is determined according to the history selection records of the seats, specifically, a selection sequence of each seat at the target location. For example, if a seat having the serial number n is first selected in a session, the selection sequence information of the seat at this time is one. When a user selects a seat at the target location, the user selects with the goal of selecting a better seat in terms of position, which updates a selection sequence of the seats. On the contrary, selection sequence information of different seats generally also reflects the superiority or inferiority of the seats, and the superiority and inferiority may be measured according to the selection sequence information.

During this step, many implementation manners are available. For example, the collection of the history selection records of the seats may be implemented by collecting the real-time data from a partner-party server. The real-time data of the partner-party server is generally data generated in real time when the user selects a seat at the site. Such data originates from the user's on-site selection. Generally, the working personnel having related experience may provide suggestions and, therefore, the selected seats are mostly the seats which are better in terms of position. In addition, the records of the seats at the target location selected by the user via the client may be collected and, thus, the selection sequence information of the seats at the same target location is acquired. In this implementation manner, if the user first selects a seat at the target location, the user may miss the best seat out of the remaining vacant seats because the user is not familiar with the distribution of the seats. However, when the user selects a seat a second time, or later at the same location, the user may select the best seat out of the remaining vacant seats due to practical experience. Therefore, when the selection sequence information of the seats is collected according to the client data, the data of the seat that is first selected by the user at the target location is excluded, but the records of the seats that are selected by the user a second time or later at the current location are collected. Hence, according to the history records, the selection sequence information of each seat is determined, thereby improving the accuracy of the collected data. Nevertheless, in a practical application, the data of the seat selection history records may also be from other origins which are not limited to embodiments described herein.

Further, with respect to the collected selection sequence information of seats at the same target location where the seats are selected, information may only be collected for the seats in a specific region/position at the current target location. For example, the seats in the specific region/position at the target location may be seats which are located in the central region in the venue and highly recommended. However, data of the seats which are located at the edge and rarely recommended is not statistically collected. As such, the priority information of a specific seat may be determined according to the selection sequence information of the seat, and finally, seat recommendation is performed according to the related data in the seat information database. In addition, the seat which has the higher recommendation value may be the only seat recommended, thereby further improving the practicability of providing seat information according to the seat information database.

The selection sequence information of each seat at the target location in one session is as listed in Table 1.

TABLE 1

| Seat ID | Selection sequence information |
|---|---|
| Z02066 | 1 |
| Z02056 | 2 |
| . . . | . . . |

In Table 1, the selection sequence information of each seat at the target location in one session is illustratively given. For example, the selection sequence information of a seat having the ID of Z02066 in this session is 1; that is, in this session, the seat having the ID of Z02066 is the first seat at the target location that is selected or locked. It should be noted that, with respect to the selection history records of the seats at the target location, a specific amount of data may be collected during data statistics so as to improve the accuracy of reflecting the priorities of various seats in the database.

In step S102, a corresponding priority score of each seat each time the seat is selected is determined according to the selection sequence information of each seat at the target location each time the seat is selected, the corresponding priority scores of the same seat each time the seat is selected are gathered, and priority information of each seat at the target location is determined.

After the history selection records of the seats at the target location are collected and the selection sequence information of each seat at the target location each time the seat is selected is determined according to the collected history records, the priority information of each seat at the target location may be determined according to the selection sequence information of each seat at the target location each time the seat is selected. During specific implementation, a corresponding priority score of each seat each time the seat is selected is determined according to the selection sequence information of each seat at the target location each time the seat is selected, the corresponding priority scores of the same seat each time the seat is selected are gathered, and priority information of each seat at the target location is determined. When the corresponding priority score of each seat each time the seat is selected is determined according to the selection sequence information of each seat at the target location each time the seat is selected, a functional relation may be established in advance; then, the corresponding priority score of each seat each time the seat is selected is determined according to both the selection sequence information of each seat at the target location each time the seat is selected and the functional relation. For example, a function with the selection sequence information as a variable may be established in advance, with the corresponding priority score used as a dependent variable of the function. For example, when the independent variable x is used to identify the selection sequence information of the seat when the seat is currently selected, and y is used to identify the priority score of the seat when the seat is selected at a particular time, the independent variable and y may be in the following relationship:

y=(m−x);

wherein m is the total quantity of the seats in at the location.

In addition, in the functional relation that is established in advance, the priority score of the seat is used as a dependent variable, wherein the priority scores descend according to a selection sequence of the seats. That is, the seat that is selected earlier has a better position and a higher priority score; a seat selected later has a worse position and a lower priority score.

Furthermore, with respect to the same seat at the target location, the selection sequence information in a plurality of sessions may be collected, and the corresponding priority scores may be respectively determined according to the plurality of pieces of selection sequence information in the plurality of sessions; then, the obtained priority scores are subjected to aggregation processing such as accumulation, averaging, and the like. Afterwards, the value obtained after processing is used as the priority score of the seat at the target location, and the obtained priority score is determined as the priority information of the corresponding seat. In this way, through a large scale of data collection, the accuracy of the priority score may be improved, that is, the accuracy of reflecting the superiority or inferiority of a seat by the priority score. In addition, in a monotone decreasing function using the selection sequence information as an independent variable and in a function using the corresponding priority score as a dependent variable, the relationship between the two variables may be linear, for example, the above y=(m−x). The priority score obtained from a linear functional relation may more directly reflect the difference of different seat priority information. Additionally, the relationship between the two variables may also be non-linear. For example:

y=(m−x)²;

wherein the variables and the letters denote the same as the above function.

The priority score obtained based on the non-linear function may increase the difference between different seat priority information, improve the advantages of the better seats, and more accurately determine the to-be-recommended seat during the seat information recommendation process.

When the selection sequence information of the seats at the same target location is collected, suboptimal data is sometimes collected due to various factors. For example, although some users can take precedence to select seats at the target location, these users may desire to exit or enter the projection hall at any time so as not to disturb other users; thus, they select the seats in the front rows or close to the door, which are generally not considered as good of seats. As such, the collected selection sequence information and the priority scores obtained according to the selection sequence information may not accommodate the actual situation (for ease of description, such selection sequence information is hereinafter referred to as interference data). Therefore, when the selection sequence information of each seat at the same target location is collected, such data needs to be excluded to obtain a more accurate priority score of the seat and, thus, to more accurately determine the priority information of each seat at the target location. During specific implementation, the distribution status of each piece of selection sequence information may be determined after the corresponding selection sequence information is collected when the same seat is selected multiple times, and priority selection is performed for the multiple pieces of selection sequence information obtained according to the distribution status. Hence, when the corresponding priority score of each seat each time the seat is selected is determined according to the selection sequence information, after a preferential selection to exclude suboptimal data, the corresponding priority score of each seat each time the seat is stored according to the selection sequence information after the preferential selection. For example, the corresponding selection sequence information of a seat when the seat has been selected six times is respectively as follows:

{12, 10, 14, 10, 12, 2}

Accordingly, the information reflects that the seat has been selected six times, the selection sequence information of the seat is mostly within the range of 14 to 12, whereas the sequence of the seat when the seat has been selected for the sixth time is 2 (e.g., by a user desiring to be near a door); within the distribution range, the data is very sparse. Therefore, it may be considered that the selection sequence information of this selection of the seat is occasional and may be thus excluded. As such, the corresponding priority scores of the seat each time the seat is selected may be determined according to the first five pieces of selection sequence information after preferential selection. The above described selection sequence information is merely an example. In practical application, the statistically collected selection times or instances may be even higher, and the employed manner for preferentially selecting the multiple pieces of selection sequence information may also not be limited to this example. After a preferential selection is made from multiple pieces of selection sequence information, the priority score of each seat is determined, which improves the accuracy of the priority score. In addition, after the priority score of each seat each time the seat is selected is determined according to the selection sequence information, a preferential selection may be made for a plurality of priority scores of the seat and, thus, the priority information is determined by aggregating the preferentially selected priority scores. In this way, the same effect may be achieved.

In addition, position distributions of different seats at the same location are subjected to a specific spatial correlation, which is generally reflected as relative to a reference seat in a central region; the seat that is closer to the reference seat has a higher priority score. Therefore, correlation between the seats may be determined according to the position distribution of the seats at the target location and, hence, the priority information of the seats at the target location is corrected according to the correlation between the seats. For example, a seat may be selected as a reference seat (for example, the seat having the highest score at the location). If a seat A is three units away from the reference seat and another seat B is eight units away from the reference seat, theoretically, the seat A gains a higher score than seat B; however, based on the statistics information, if it is determined that the priority score of the seat A is higher than the priority score of the seat B, the priority information of at least one of the two seats may be corrected according to the spatial correlation between the seat A and the seat B.

In step S103, seat information of each seat at the target location and the priority information corresponding to each seat are stored as items of the seat information database. After the priority information of the seats at the target location is determined, the seat information of the seats at the target location and the priority information corresponding to the seats may be stored as items of the seat information database. The seat information may be computer data expressions of the seats at the target location or the positions of the seats; for example, a seat may be represented in the form of a two-tuple, wherein the data respectively represents rows and columns of the seats. For example, information of a seat may be represented by (8, 7), which indicates the seat in the eighth row and seventh column at the target location. In addition, the seat information may also be represented by using a unique serial number ID; for example, a seat in the projection hall of a movie theatre may be represented as Z02066. Different venue locations may have the same seat distribution with respect to the target location. For example, the same-type movie projection halls of the same service providers generally have the same seat deployment, arrangement, or configuration. Therefore, the locations having the same or similar seat deployment may be categorized into the same group. As such, the target location may comprise a plurality of locations of the same type. When database data is generated or the database is queried, the type information representing the same or similar seat deployment may be used as a keyword of the item of the database.

As described above, the seat information and the priority information of the seat may be respectively described by using a specific form of computer data. A typical item of the seat information database is as follows:

Z02066-98.

In the above example, the seat information in the items of the seat information database is identified by a unique serial number ID and the corresponding priority score. As described above, the target location may comprise a plurality of locations having the same or similar seat distribution. Therefore, in the items of the seat information database, the seat information (for example, the seat serial number ID) may identify the seats in the same position at locations of the same type. As illustrated in the above example, when the priority information of each seat is identified by means of a priority score, the seat information of the seats at the target location and the priority information corresponding to the seats may be stored as items of the seat information database.

The method for establishing a seat information database according to an embodiment is described in detail above. With the method, history seat selection records at a target location may be collected, selection sequence information of each seat at the target location each time the seat is selected is determined according to the history seat selection records of a user, priority information of each seat at the target location is determined according to the selection sequence information of each seat at the target location each time the seat is selected, and seat information of each seat at the target location and the priority information corresponding to each seat are stored as items of the seat information database. The seat priority information for reflecting the superiority or inferiority of a seat originates from statistical collection and accumulation of the data of user's selection of the seat. Hence, more accurate seat priority information is obtained according to the history seat selection records of the user, which more objectively reflects the priority of the position of the seat. In this way, the determined priority information of each seat is more accurate.

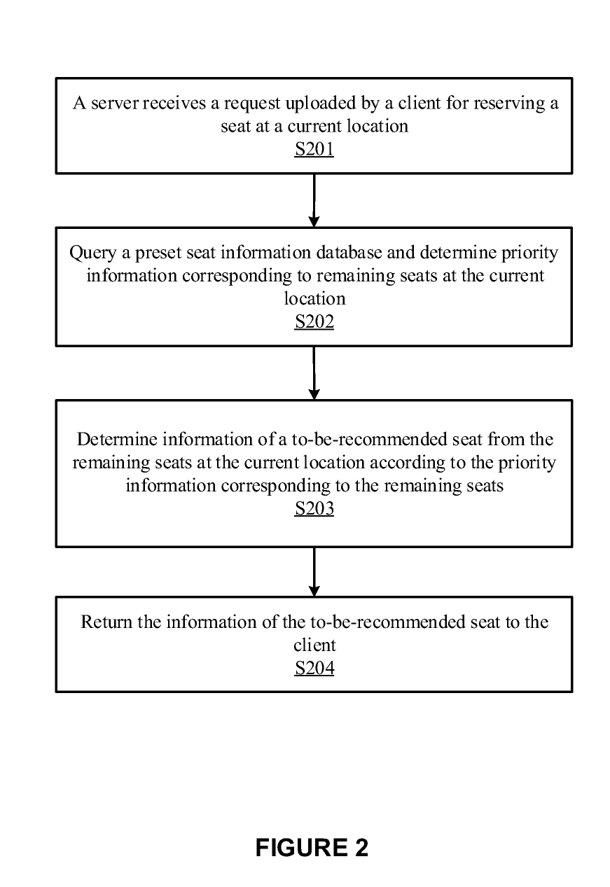

An embodiment includes a method for providing seat information. According to the method, when a user selects a seat or reserves a seat at a current location, the best seat out of the remaining vacant seats at a target location may be accurately or proactively provided to the user by inquiring into a seat information database. This saves the operation time elapsed when the user selects a seat and improves the efficiency of seat reservation for the user. As illustrated in FIG. 2, the method for providing seat information may comprise the following steps.

In step S201, a server receives a request uploaded by a client for reserving a seat at a current location.

When a user reserves a seat by using an application installed on a terminal device, the user may upload the request for reserving a seat at the current location via the client, and the server may receive via the Internet the request uploaded via the client for reserving a seat at the current location. The request for reserving a seat may comprise identifier information of the current location, for example, type serial number of the current location and the like, such that the server can determine the current location or type of the current location and query an information database based on the identifier information. The request for reserving a seat may also carry such information as a reservation quantity of seats, a location identifier of the reserved seats, verification information of a user, identifier information, or the like, such that the server can complete such tasks as user verification, collection or recording of the reservation information, and the like according to such information.

In step S202, a preset seat information database is queried and priority information corresponding to remaining seats at the current location is determined, wherein the seat information database is established according to selection sequence information of each seat in a seat selection history record each time the seat is selected, and information of each seat at the current location and corresponding priority information are stored in the seat information database.

After receiving the request for reserving a seat at the current location, the server may query a preset seat information database and determine priority information corresponding to the remaining seats at the current location, wherein the seat information database may be preset in the server. In this embodiment, the seat information database is established according to selection sequence information of each seat in a seat selection history record each time the seat is selected. Information of each seat at the current location and corresponding priority information are stored in the seat information database. The method for generating a seat information database may be referenced to the method for establishing a seat information database. In the seat information database, a piece of seat information may comprise a field identifying whether the seat is vacant (or whether the seat has been reserved), a numerical value of the field may be a numerical value of Boolean (e.g., Bool) type to identify the vacant status (or whether the seat has been reserved) of the corresponding seat, and the value may be changed according to real-time data of the reserved seats, so that the vacant status (reservation status) of each seat in each target location is recorded. When the preset seat information database is queried, the information of the seats in the vacant status at the current location may be first determined, and the priority information of each seat in the vacant status may be determined second. The priority information of each vacant seat at the current location may be presented in a specified data form; for example, different priority information is identified by using different priority scores so as to preferably select the seat in the subsequent steps and return the best seat information (e.g., information of one or multiple seats with the highest score) to the client.

In step S203, information of a to-be-recommended seat is determined from the remaining seats at the current location according to the priority information corresponding to the remaining seats. After the priority information of the seats at the designated location is determined, information of a to-be-recommended seat may be determined from the remaining vacant seats at the currently designated location according to the priority information of the remaining seats. To be specific, position information of the seats among the remaining seats at the current location, (for example, the row number or column number), the serial number of the seat at the current location, or the like may be determined. Generally, in the seat information database, a seat having a better position corresponds to higher priority information. Therefore, in response to the current request, one or a plurality of remaining vacant seats having higher priority information may be determined according to the priority information of the remaining seats, and the information of the one or plurality of remaining vacant seats may be determined as the information of the to-be-recommended seat.

When a user reserves one or multiple seats via the client, the information of the reservation quantity of seats can be carried in the uploaded reservation request. After receiving the reservation request from the client, the server may perform the following: determine the reservation quantity of seats according to the reservation request, determine information of a to-be-recommended seat from the remaining seats at the current location and information of a seat having a specific relative position relationship from the remaining seats at the current location according to the priority information corresponding to the remaining seats and the reservation quantity. The determined information is used to provide the information of the to-be-recommended seat. For example, the reservation quantity of seats is two, and a user desires to reserve two seats adjacent to each other in the horizontal direction under normal conditions. In this case, the seat having the highest priority information from the current remaining seats can be determined first, and whether the seats adjacent to each other in the horizontal direction are vacant is determined second. If the seats adjacent to each other in the horizontal direction are not vacant, the seat information lower than the priority of the highest priority seat is determined from the current remaining seats, and whether the seats adjacent to each other in the horizontal direction are vacant is determined, and so on. This is done until the seat information of the vacant seats adjacent to each other in the horizontal direction is determined, and the seat information of the vacant seats adjacent to each other in the horizontal direction is used as the information of the to-be-recommended seat.

In step S204, the information of the to-be-recommended seat is returned to the client. After the information of the to-be-recommended seat is determined from the remaining vacant seats at the current location, the information of the to-be-recommended seat may be returned to the client such that it is convenient for the client to access the information of the to-be-recommended seat. For example, according to the information of the to-be-recommended seat, one or more seats having better positions from the remaining vacant seats may be recommended to the user via the client application, which facilitates selection of better seats from the remaining vacant seats. In addition, when the information of the to-be-recommended seat is returned to the client, other data about the to-be-recommended seat may also be returned; for example, the priority information of each seat that is stored in the seat information database is stored in the form of a priority score of each seat. When the information of the to-be-recommended seat is returned, the priority score of each to-be-recommended seat is returned to the client for the reference of the user during the seat selection. For example, a real effect view of each seat may be stored in the server in advance, and when the information of the to-be-recommended seat is returned, the real effect view of each to-be-recommended seat is returned to the client for better acknowledgement of such information as position or the like of the to-be-recommended seat.

In addition, when accepting the returned information of the to-be-recommended seat, the user selects the to-be-recommended seat via the client. At this moment, a selection result of the to-be-recommended seat of the user via the client may be used as sample data, wherein the sample data is used to optimize the priority information of the related seat in the seat information database. To be specific, the selection result of the to-be-recommended seat of the user via the client may be first received, and the priority information of the related seat in the seat information database is updated according to a selection sequence of the seat in the selection result.

The above gives a detailed description of the method for providing seat information according to an embodiment. According to the method, after a server receives a request for reserving a seat at a current location, a preset seat information database is queried, information of a to-be-recommended seat is determined from the remaining vacant seats at the current location according to priority information of each seat at the current location that is stored in the seat information database; then, the information of the to-be-recommended seat is returned to a client, wherein the seat information database is established according to selection sequence information of each seat in a seat selection history record each time the seat is selected, which may more accurately reflect good and poor seats at the current location. In this way, when the users reserve seats at the current location via the client, the seats which are better in terms of position out of the remaining seats may be quickly and accurately provided to the users. This avoids the case in which users may only select seats according to their experience and subjective judgment but cannot select better seats and, in the meantime, saves the operation time elapsed when the users select seats and also improves the efficiency of seat reservation via the client.

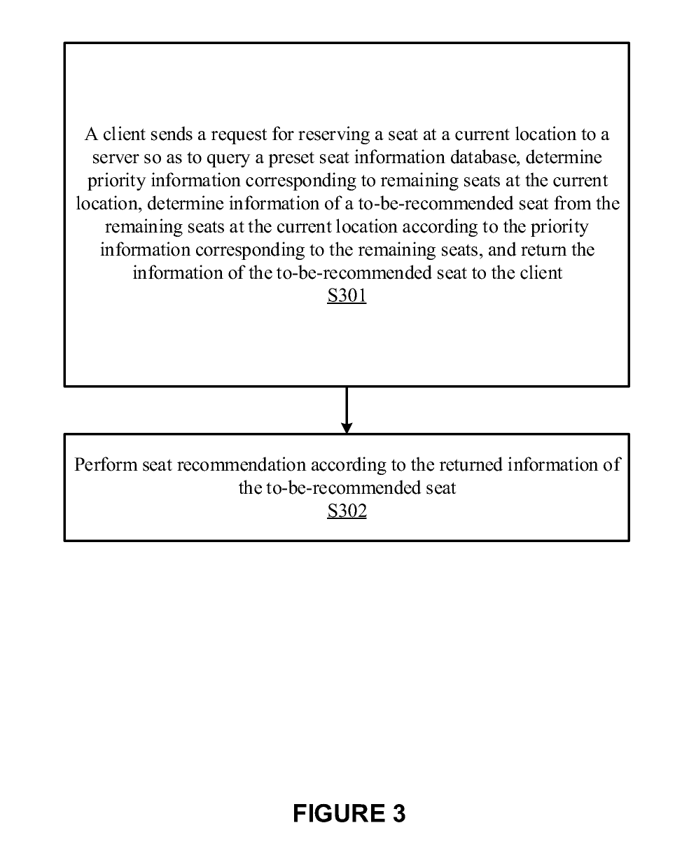

An embodiment includes a method for providing seat information. From the perspective of a client, information of a seat which is better in position out of the remaining vacant seats at a current location is provided to a user by using a seat information database preconfigured at a server end. Referring to FIG. 3, the method may comprise the following steps.

In step S301, a client sends a request for reserving a seat at a current location to a server. The request is configured to query a preset seat information database, determine priority information corresponding to remaining seats at the current location, determine information of a to-be-recommended seat from the remaining seats at the current location according to the priority information corresponding to the remaining seats, and return the information of the to-be-recommended seat to the client. The seat information database is established according to selection sequence information of each seat in a seat selection history record each time the seat is selected, and information of each seat at the current location and corresponding priority information are stored in the seat information database.

When a user reserves a seat at the current location via a client, the client may query the preset seat information database and determine the corresponding priority information of the remaining seats at the current location. The information of the seats at the current location and the corresponding priority information are stored in the seat information database. In addition, the seat information database is established according to the selection sequence information of the seats in the seat selection history records each time the seats are selected, based on the selection sequence data of the seats at the current location from the users. Therefore, the data in the seat information database can more accurately reflect the superiority or inferiority of different seats. Hence, information of a to-be-recommended seat from the remaining seats at the current location may be determined according to the priority information corresponding to the remaining seats.

In step S302, seat recommendation is performed according to the returned information of the to-be-recommended seat. Upon receiving the information of the to-be-recommended seat returned by the server, the client may perform seat recommendation according to the information of the to-be-recommended seat. In addition, if the user is not satisfied with the information of the to-be-recommended seat or the recommended information fails to accommodate the actual needs of the user, a manual selection option may be provided for the user to manually select another non-recommended seat. After the recommended information is provided, an effective selection is made for the seat of the user, and the user's selection result may be uploaded to the server such that the user corrects or optimizes the data in the seat information database according to the manual selection result, thereby further enhancing the accuracy of the data in the seat information database.

In the method according to the embodiment, the priority information of the seats at the current location is stored in the preset seat information database in the server. The data in the seat information database originates from statistical collection of data of the user's seat selection behavior, which may objectively and accurately reflect the priority status of the positions of the seat. When the user reserves a seat at the current location via the client, a reservation request may be sent to the server according to the actual needs of the user, and upon inquiring into the seat information database, the server may quickly and accurately provide information regarding a better seat out of the remaining vacant seats for the client. The client automatically recommends the information of the to-be-recommended seat to the user according to the information of the to-be-recommended seat. This avoids the case where the users may only select seats according to their experience and subjective judgment but cannot select better seats and, in the meantime, saves the operation time elapsed when the users select seats and improves the efficiency of seat reservation via the client.

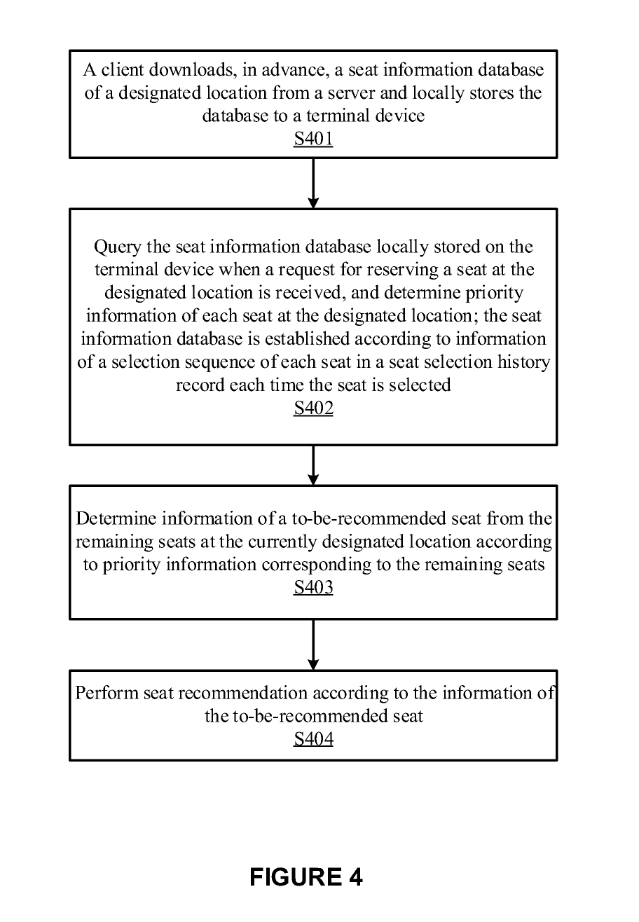

The popularity of smart terminal devices and computer networks creates great convenience for the implementation of network applications in a terminal device. In one embodiment, data of a seat information database may also be stored on a client. For example, when a user starts a client to reserve a seat, real-time seat information may be downloaded to the local terminal device via the Internet. As such, during providing of the seat information, the method for providing seat information according to this embodiment may be employed. As illustrated in FIG. 4, the method may comprise the following steps.

In step S401, a client downloads, in advance, a seat information database of a designated location from a server and locally stores the database to a terminal device. The client may download the seat information of the seats at a designated location to the local end. The designated location may be a location collected by the user a designated target location, a target location determined by the user according to the user's preference, the geographic location of the user, or the like. The client may request data from the server periodically or according to a time designated by the user, or may temporarily download the data when starting such applications as an application for reserving a seat. In addition, the time for downloading the seat information data may be determined according to the user's use preference of the application. For example, if a user usually uses the related application on holidays or weekends, the seat information database at the designated location may be downloaded and stored to the local end of the terminal device.

In step S402, the seat information database locally stored on the terminal device is queried when a request for reserving a seat at the designated location is received and priority information of each seat at the designated location is determined. The seat information database is established according to selection sequence information of each seat in a seat selection history record each time the seat is selected, and information of each seat at the designated location and corresponding priority information are stored in the seat information database.

When the user reserves a seat at the designated location via the client, the client may receive the request to reserve a seat at the designated location. When the request to reserve a seat at the designated location is received, the seat information database stored locally in the terminal device may be queried, and then, the priority information of the seats at the current location may be determined. The priority information of the seats at the target location is stored in the seat information database stored locally on the client. In addition, in the embodiment, the seat information database is established according to the selection sequence information of the seats in the seat history selection records each time the seats are selected.

In step S403, information of a to-be-recommended seat from remaining seats at the currently designated location is determined according to priority information corresponding to the remaining seats. After the priority information of the seats at the designated location is determined, information of a to-be-recommended seat may be determined from the remaining vacant seats at the currently designated location according to the priority information of the remaining seats. The information of the to-be-recommended seat may be information of the position of the to-be-recommended seat at the current location (e.g., the row number or column number), the serial number of the seat at the current location, or the like. Generally, in the seat information database, a seat having a better position corresponds to higher priority information. Therefore, in response to the current request, one or a plurality of vacant seats having higher priority information may be determined according to the priority information of the seats, and the information of one or plurality of vacant seats may be determined as the information of the to-be-recommended seat. Further, when the user reserves one or more seats via the client, information of one or more to-be-recommended seats may be determined from the currently remaining vacant seats according to the priority information of the seats and a reservation quantity of seats so as to accommodate the reservation needs of different reservation quantities.

In step S404, seat recommendation is performed according to the information of the to-be-recommended seat. After the information of the to-be-recommended seat is determined from the remaining vacant seats at the currently designated location, the information of the to-be-recommended seat may be returned to the client such that it is convenient for the client to access the information of the to-be-recommended seat. For example, according to the information of the to-be-recommended seat, a seat having a better position from the remaining vacant seats may be recommended to the user via the client application, which facilitates more convenient selection by the user of a more desirable seat when the user reserves a seat at the target location.

The method for providing seat information according to an embodiment is described in detail in the above. With the method, when a user reserves a seat at a currently designated location via a client, a request for reserving a seat at the currently designated location may be received via the client and, thus, a local seat information database is queried via the client to determine priority information of the remaining seats at the currently designated location; then, a seat that is better in position is accurately determined from the remaining vacant seats according to the priority information of the remaining seats and seat information corresponding to the determined seat is returned as information of a to-be-recommended seat, such that the seat that is better in position at the currently designated location is automatically recommended to the user. With the method, the operation time elapsed when the user selects a seat is saved, and the efficiency of reserving seats via the client is improved.

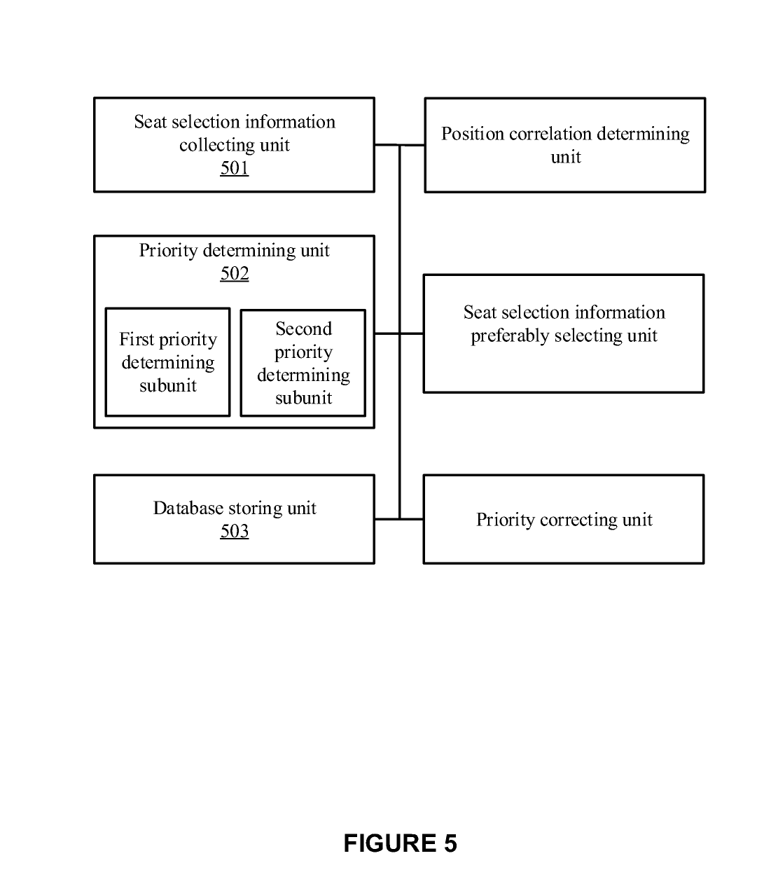

Corresponding to the method for establishing a seat information database, an embodiment further includes an apparatus for establishing a seat information database. As illustrated in FIG. 5, the apparatus may comprise a seat selection information collecting unit 501, a priority determining unit 502, and a database storing unit 503.

The seat selection information collecting unit 501 is configured to collect a seat selection history record at a target location and determine, according to the history record, selection sequence information for each seat at the target location each time the seat is selected.

The priority determining unit 502 is configured to determine, according to the selection sequence information of each seat at the target location each time the seat is selected, a corresponding priority score of each seat each time the seat is selected, gather the corresponding priority scores of the same seat each time the seat is selected, and determine priority information of each seat at the target location.

The database storing unit 503 is configured to store seat information for each seat at the target location and the priority information corresponding to each seat as items of the seat information database.

In another implementation manner, a functional relation may be established in advance, wherein in the functional relation, the selection sequence information of the seat is used as an independent variable, the priority score of the seat is used as a dependent variable, the priority score of the seat sequentially descends according to the selection sequence of the seat, and the functional relation comprises a linear or a nonlinear relationship. In such an implementation manner, the priority determining unit 502 may comprise a first priority determining subunit. The first priority determining subunit is configured to determine, according to the selection sequence information of each seat at the target location each time the seat is selected and the functional relation, the corresponding priority score of each seat each time the seat is selected.

In addition, the apparatus for establishing a seat information database may further comprise a position correlation determining unit and a priority correcting unit. The position correlation determining unit is configured to determine the correlation between seats according to the position distribution of each seat at the target location. The priority correcting unit is configured to correct the priority information of each seat at the target location according to the correlation between the seats.

In another implementation manner, the apparatus for establishing a seat information database may further comprise a seat selection information preferably selecting unit. The seat selection information preferably selecting unit is configured to determine the distribution status of each piece of selection sequence information after the corresponding selection sequence information is collected when the same seat is selected multiple times, and perform priority selection for multiple pieces of selection sequence information according to the distribution status.

The priority determining unit 502 may comprise a second priority determining subunit. The second priority determining subunit is configured to determine, according to the selection sequence information after the preferential selection, the corresponding priority score of each seat each time the seat is selected.

The apparatus for establishing a seat information database according to an embodiment is described in detail above. With the apparatus, history seat selection records at a target location may be collected, selection sequence information of each seat at the target location each time the seat is selected is determined according to the history seat selection records of a user, priority information of each seat at the target location is determined according to the selection sequence information of each seat at the target location each time the seat is selected, and seat information of each seat at the target location and the priority information corresponding to each seat are stored as items of the seat information database. The seat priority information for reflecting the superiority or inferiority of a seat originates from statistical collection and accumulation of the data of user's selection of the seat such that the seat priority information obtained according to the history seat selection records of the user more objectively reflects the priority of the position of the seat.

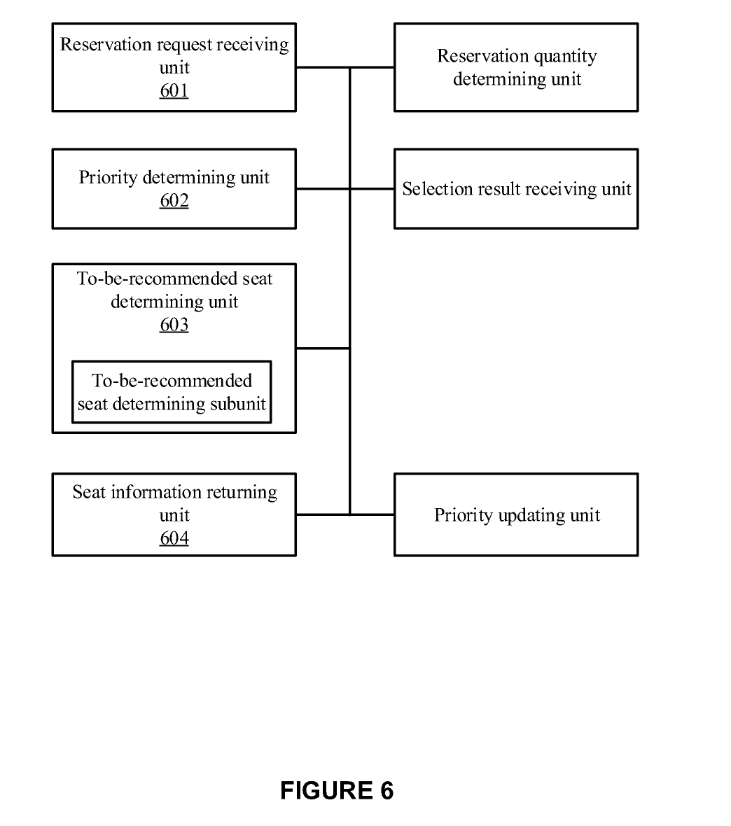

Corresponding to the method for providing seat information, an embodiment further includes an apparatus for providing seat information. As illustrated in FIG. 6, the apparatus may comprise a reservation request receiving unit 601, a priority determining unit 602, a to-be-recommended seat determining unit 603, and a seat information returning unit 604.

The reservation request receiving unit 601 is configured to receive a request uploaded by a client for reserving a seat at a current location. The priority determining unit 602 is configured to query a preset seat information database and determine priority information corresponding to the remaining seats at the current location. The seat information database is established according to selection sequence information of each seat in a seat selection history record each time the seat is selected, with both the information regarding each seat at the current location and the corresponding priority information being stored in the seat information database. The to-be-recommended seat determining unit 603 is configured to determine information of a to-be-recommended seat from the remaining seats at the current location according to the priority information corresponding to the remaining seats. The seat information returning unit 604 is configured to return the information of the to-be-recommended seat to the client.

In another implementation manner, the apparatus for providing seat information may further comprise a reservation quantity determining unit. The reservation quantity determining unit is configured to determine a reservation quantity of seats at the current location corresponding to the current request.

In such an implementation manner, the to-be-recommended seat determining unit 603 may comprise a to-be-recommended seat determining subunit. The to-be-recommended seat determining subunit is configured to determine information of a seat having a specific relative position relationship from the remaining seats at the current location according to the priority information corresponding to the remaining seats and the reservation quantity, and use the determined information as the information of the to-be-recommended seat.

In addition, the apparatus for providing seat information may further comprise a selection result receiving unit and a priority updating unit. The selection result receiving unit is configured to receive a result of selection of the to-be-recommended seat made by a user via the client. The priority updating unit is configured to update priority information of a related seat in the seat information database according to a selection sequence of the seat in the selection result.

The above gives a detailed description of the apparatus for providing seat information according to an embodiment. According to the apparatus, after a server receives a request for reserving a seat at a current location, a seat information database is queried, information of a to-be-recommended seat is determined from the remaining vacant seats at the current location according to priority information of each seat at the current location that is stored in the seat information database. Then, the information of the to-be-recommended seat is returned to a client. The seat information database is established according to selection sequence information of each seat in a seat selection history record each time the seat is selected, which may more accurately reflect good and poor seats at the current location. In this way, when users reserve seats at the current location via the client, the seats which are better in terms of position out of the remaining seats may be quickly and accurately provided to the users. This avoids the case where the users may only select seats according to their experience and subjective judgment and improves the efficiency of seat reservation via the client.

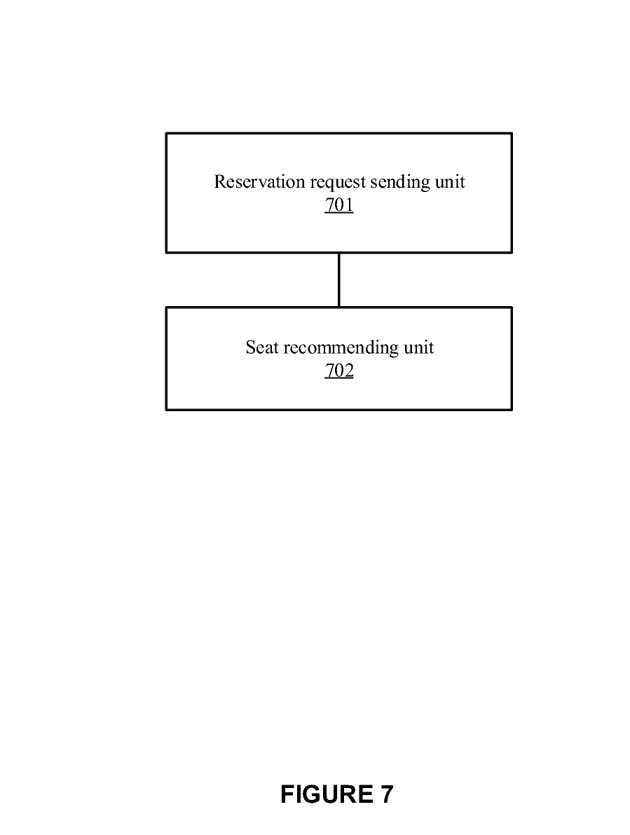

Corresponding to the method for providing seat information, an embodiment further includes an apparatus for providing seat information. As illustrated in FIG. 7, the apparatus may comprise a reservation request sending unit 701 and a seat recommending unit 702. The reservation request sending unit 701 is configured to send a request for reserving a seat at a current location from a client to a server so as to query a preset seat information database, determine priority information corresponding to remaining seats at the current location, determine information of a to-be-recommended seat from the remaining seats at the current location according to the priority information corresponding to the remaining seats, and return the information of the to-be-recommended seat to the client. The seat information database is established according to selection sequence information of each seat in a seat selection history record each time the seat is selected, with both information of each seat at the current location and corresponding priority information being stored in the seat information database. The seat recommending unit 702 is configured to perform a seat recommendation according to the returned information of the to-be-recommended seat.

In the apparatus according to the embodiment, the priority information of the seats at the current location is stored in the seat information database on the server. The data in the seat information database originates from statistical collection of the data of the user's seat selection behavior, which may objectively and accurately reflect the priority status of the positions of the seat. When the user reserves a seat at the current location via the client, a reservation request may be sent to the server according to the actual needs of the user and, upon querying the seat information database, the server may quickly and accurately provide information of a better seat out of the remaining vacant seats for the client. The client automatically recommends the information of the to-be-recommended seat to the user according to the information of the to-be-recommended seat. This avoids the case where the users may only select seats according to their limited experience and subjective judgment, thus making it difficult for users to select better seats and, in the meantime, saves the operation time elapsed when the users select seats and also improves the efficiency of seat reservation via the client.

Corresponding to the method for providing seat information, an embodiment further includes a computer-readable medium having stored thereon, computer-executable instructions that, if executed by a processor, cause the processor to perform a method comprising: sending a request for reserving a seat at a current location from a client to a server so as to query a preset seat information database, determine priority information corresponding to remaining seats at the current location, determine information of a to-be-recommended seat from the remaining seats at the current location according to the priority information corresponding to the remaining seats, and return the information of the to-be-recommended seat to the client, where the seat information database is established according to selection sequence information of each seat in a seat selection history record each time the seat is selected, and where information of each seat at the current location and corresponding priority information is stored in the seat information database; and presenting a seat recommendation according to the returned information of the to-be-recommended seat.

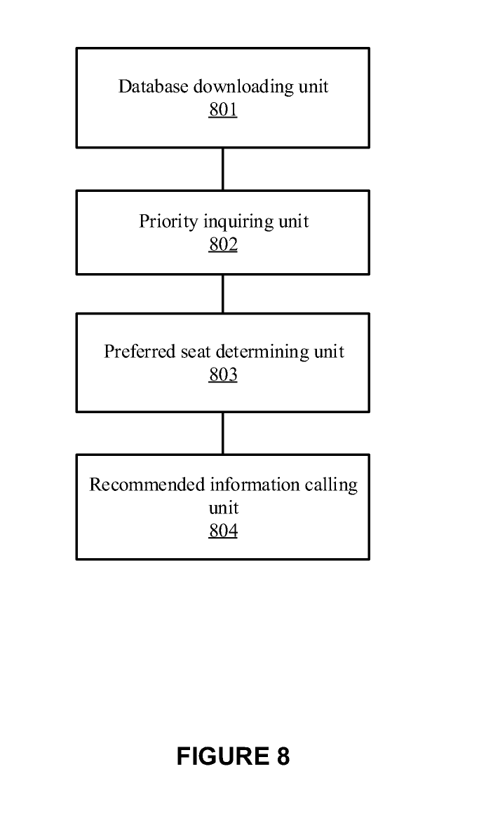

Corresponding to the method for providing seat information, an embodiment further includes an apparatus for providing seat information. As illustrated in FIG. 8, the apparatus may comprise a database downloading unit 801, a priority inquiring unit 802, a preferred seat determining unit 803, and a recommendation information calling unit 804. The database downloading unit 801 is configured to download in advance a seat information database of a designated location from a server and locally store the database on a terminal device. The priority inquiring unit 802 is configured to query the seat information database locally stored on the terminal device when a request for reserving a seat at the designated location is received and determine priority information of each seat at the designated location. The seat information database is established according to the selection sequence information of each seat in a seat selection history record each time the seat is selected, and information of each seat at the designated location and corresponding priority information is stored in the seat information database. The preferred seat determining unit 803 is configured to determine information of a to-be-recommended seat from the remaining seats at the currently designated location according to the priority information corresponding to the remaining seats. The recommendation information calling unit 804 is configured to perform the seat recommendation according to the information of the to-be-recommended seat.

With the apparatus, when a user reserves a seat at a currently designated location via a client, a request for reserving a seat at the currently designated location may be received via the client and thus, a local seat information database is queried via the client to determine priority information of the remaining seats at the currently designated location; then, a seat that is better in position is accurately determined from the remaining vacant seats according to the priority information of the remaining seats and seat information corresponding to the determined seat is returned as information of a to-be-recommended seat such that the seat which is better in position at the currently designated location is automatically recommended to the user. With the method, the operation time elapsed when the user selects a seat is saved, and the efficiency of reserving seats via the client is improved.

As evident from the above description of the embodiments, embodiments may be implemented by means of software plus a universal hardware platform. Based on such understanding, portions of the technical solutions may be embodied in the form of a software product; the computer software product may be stored in a storage medium, such as a ROM/RAM, a magnetic disk, a CD-ROM, and the like, including several instructions for causing a computer device (a personal computer, a server, or a network device) to perform the various embodiments, or certain portions of the method of the embodiments.

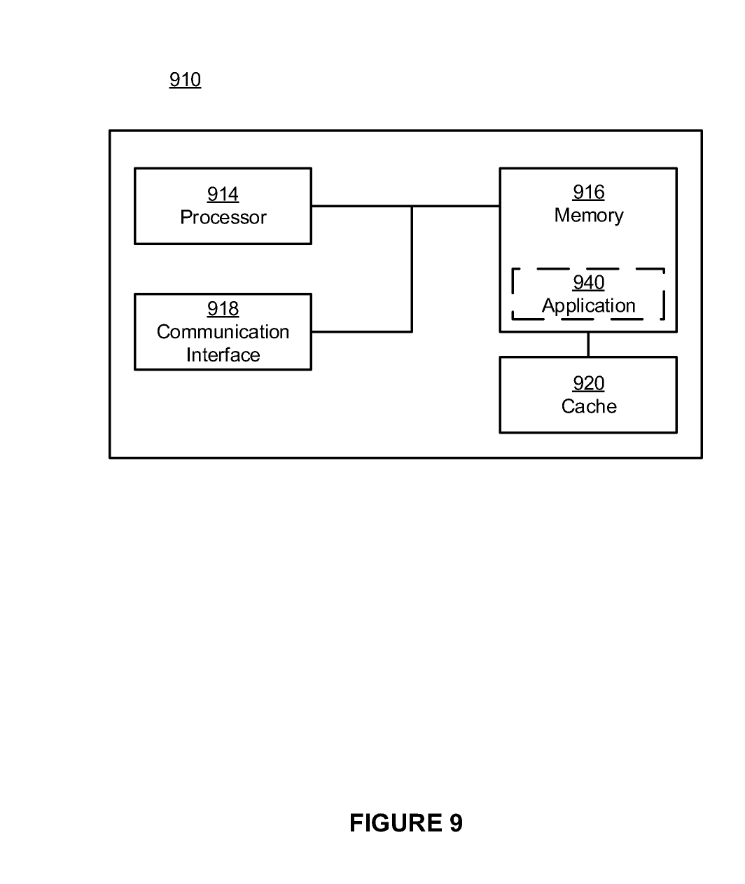

FIG. 9 is a block diagram of an example of a computing device 910 capable of implementing embodiments according to the present disclosure. The device 910 broadly includes any single or multi-processor computing device or system capable of executing computer-readable instructions, such as those described in conjunction with FIGS. 1-4. That is, the device 910 can be implemented as a client for processing an unstructured message, a server for processing an unstructured message, a platform for processing an unstructured message, or a system for processing an unstructured message. In its most basic configuration, the device 910 may include at least one processing circuit (e.g., the processor 914) and at least one non-volatile storage medium (e.g., the memory 916).

The processor 914 generally represents any type or form of processing unit or circuit capable of processing data or interpreting and executing instructions. In certain embodiments, the processor 914 may receive instructions from a software application or module. These instructions may cause the processor 914 to perform the functions of one or more of the example embodiments described and/or illustrated herein.

The system memory 916 generally represents any type or form of volatile or non-volatile storage device or medium capable of storing data and/or other computer-readable instructions. Examples of system memory 916 include, without limitation, RAM, ROM, flash memory, or any other suitable memory device. Although not required, in certain embodiments the node 910 may include a volatile memory unit in addition to a non-volatile storage unit. In an embodiment, the system memory 916 includes a cache 920.

The device 910 may also include one or more components or elements in addition to the processor 914 and the system memory 916. For example, the device 910 may include a memory device, an input/output (I/O) device, and a communication interface 918, each of which may be interconnected via a communication infrastructure. The communication interface 918 broadly represents any type or form of communication device or adapter capable of facilitating communication between the device 910 and one or more other devices.

The device 910 can execute an application 940 that allows it to perform operations (e.g., the operations of FIGS. 1, 5, 6, 10, 11 and 12). A computer program containing the application 940 may be loaded into the device 910. For example, all or a portion of the computer program stored on a computer-readable medium may be stored in the memory 916. When executed by the processor 914, the computer program can cause the processor to perform and/or be a means for performing the functions of the example embodiments described and/or illustrated herein. Additionally or alternatively, the example embodiments described and/or illustrated herein may be implemented in firmware and/or hardware.

The embodiments in this specification are described in a progressive manner. Each embodiment is focused on differences from other embodiments, with cross-referencing available for identical or similar parts among different embodiments. Those skilled in the art will realize that an embodiment among the embodiments of the present disclosure may be provided as a method, an apparatus, or a computer program product. Therefore, embodiments of the present disclosure may use forms of a full hardware embodiment, a full software embodiment, or an embodiment combining both software and hardware aspects. Furthermore, embodiments of the present disclosure may use forms of computer program products implemented on one or more computer storage media (including, but not limited to, a magnetic disk memory, a CD-ROM, an optical memory, or the like), which includes computer program code.

In an embodiment, the computer equipment includes one or more CPUs, input-output interfaces, network interfaces, and memories. A memory may include a volatile memory in a computer-readable medium, a RAM, and/or a non-volatile memory, such as a ROM or a flash RAM. A memory is an example of a computer-readable medium. A computer-readable medium includes a non-volatile medium, a volatile medium, a mobile medium, or an immobile medium, which may implement information storage by means of any method or technology. Information may be a computer-readable instruction, a data structure, a module of a program, or other data. Examples of computer storage media include, but are not limited to, a phase change RAM (PRAM), a static RAM (SRAM), a dynamic RAM (DRAM), other types of RAM, a ROM, an EEPROM, a flash memory or other memory technologies, a CD-ROM, DVD or other optical memories, a cartridge magnetic tape, a magnetic tape or magnetic disk memory, or other magnetic storage devices or any other non-transmission media, which may be configured to store information that can be accessed by a computing device. As defined herein, computer-readable media do not include transitory media such as, for example, modulated data signals and carriers.

Embodiments of the disclosure are described with reference to flowcharts and/or block diagrams of the method in the embodiments of the disclosure, a terminal device (system), and a computer program product. It should be understood that each flowchart and/or block in the flowcharts and/or block diagrams and a combination thereof may be implemented by means of computer program instructions. These computer program instructions may be provided for a general-purpose computer, a special-purpose computer, an embedded processor, or processors of other programmable data processing terminal equipment to generate a machine, so as to generate an apparatus configured to implement designated functions in one or more steps of a flowchart and/or one or more blocks of a block diagram by means of instructions executed by a computer or a processor of other programmable data processing terminal equipment. These computer program instructions may also be stored in a computer-readable memory that can guide a computer or other programmable data processing terminal equipment to work in a particular way, so that the instructions stored in the computer-readable memory generate a manufactured product, including a command device that implements the designated functions in one or more flows of a flowchart and/or one or more blocks of a block diagram. These computer program instructions may also be loaded on a computer or other programmable data processing terminal equipment to execute a series of operating steps on the computer or other programmable terminal equipment to generate treatments implemented by the equipment, so that instructions executed on the computer or other programmable terminal equipment provide steps configured to implement designated functions in one or more flows of a flowchart and/or one or more blocks of a block diagram.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

Although embodiments of the disclosure have been described, those skilled in the art may make additional alterations and modifications on these embodiments as soon as they know the basic creative concept. Therefore, the appended claims are intended to be interpreted as comprising those embodiments and all alterations and modifications falling within the scope of embodiments of the application.

Finally, a relational term (such as “a first” or “a second”) is merely intended to separate one entity or operation from another entity or operation instead of requiring or hinting that any practical relation or sequence exists among these entities or operations. Furthermore, terms such as “comprise,” “include,” or other variants thereof are intended to cover a non-exclusive “comprise” so that a process, a method, a commodity, or a terminal device comprising a series of elements not only includes these elements, but also includes other elements not listed explicitly, or also includes inherent elements of the process, the method, the commodity, or the terminal device. In the case of no additional restrictions, elements restricted by a sentence “include a . . . ” do not exclude the fact that additional identical elements may exist in a process, a method, a commodity, or a terminal device of these elements.

Various embodiments in the specification are described in a progressive manner. The same or similar parts between the embodiments may reference each other. In each embodiment, the portion that is different from other embodiments is detailed and described. In particular, with respect to a system or a system embodiment, since it is substantially similar to the method embodiment, a brief description is given. The related portions may be referenced to in the description of the portions in the method embodiments. The above-described system and system embodiments are merely for illustrative purposes only. The units which are described as separate components may be physically separated or may not be physically separated, and the components which are illustrated as units may be or may not be physical units; that is, the components may be located in the same position or may be distributed into a plurality of network units. Part or all of the modules may be selected according to the actual needs to achieve the objectives of the technical solutions of the embodiments. Persons of ordinary skill in the art may understand and implement the present invention without paying any creative effort.

The method and apparatus for providing seat information are described in detail above. In the specification, the principles and implementation are illustrated with reference to specific exemplary embodiments or examples. However, the description of the above embodiments is merely for ease of understanding the method and core concepts. In the meantime, persons of ordinary skill in the art may derive variations or modifications to the present invention based on the concepts of the embodiments and application scope thereof. In conclusion, the content of the specification shall not be construed as limiting the embodiments.

What is claimed is:

1. A method for providing seat information, the method comprising:
receiving, by a server, a request uploaded by a client for reserving a seat at a current location;
inquiring into a preset seat information database and determining priority information corresponding to remaining seats at the current location, wherein the seat information database is established according to selection sequence information of each seat in a seat selection history record each time the seat is selected, and wherein information of each seat at the current location and corresponding priority information is stored in the seat information database;
determining information of a to-be-recommended seat from the remaining seats at the current location according to the priority information corresponding to the remaining seats; and
returning the information of the to-be-recommended seat to the client.

2. The method according to claim 1 further comprising:
determining a reservation quantity of seats at the current location corresponding to the current request; and
wherein the determining information of the to-be-recommended seat from the remaining seats at the current location according to the priority information corresponding to the remaining seats comprises:
determining information of a seat having a specific relative position relationship from the remaining seats at the current location according to the priority information corresponding to the remaining seats and the reservation quantity, and using the determined information as the information of the to-be-recommended seat.

3. The method according to claim 1 further comprising:
receiving a result of a selection of the to-be-recommended seat made by a user via the client; and
updating priority information of a related seat in the seat information database according to a selection sequence of the seat in the selection result.

4. A method for providing seat information, the method comprising:
sending, by a client to a server, a request for reserving a seat at a current location so as to query a preset seat information database, determine priority information corresponding to remaining seats at the current location, determine information of a to-be-recommended seat from the remaining seats at the current location according to the priority information corresponding to the remaining seats, and return the information of the to-be-recommended seat to the client, wherein the seat information database is established according to selection sequence information of each seat in a seat selection history record each time the seat is selected, and wherein information of each seat at the current location and corresponding priority information is stored in the seat information database; and
performing a seat recommendation according to the returned information of the to-be-recommended seat.

5. A method for providing seat information, the method comprising:
downloading in advance, by a client, a seat information database of a designated location from a server and locally storing the database on a terminal device;
inquiring into the seat information database locally stored on the terminal device when a request for reserving a seat at the designated location is received and determining priority information of each seat at the designated location, wherein the seat information database is established according to selection sequence information of each seat in a seat selection history record each time the seat is selected, and wherein information of each seat at the designated location and corresponding priority information is stored in the seat information database;
determining information of a to-be-recommended seat from remaining seats at the currently designated location according to priority information corresponding to the remaining seats; and
performing seat recommendation according to the information of the to-be-recommended seat.

6. A method for establishing a seat information database, the method comprising:
collecting a seat selection history record at a target location and determining, according to the history record, selection sequence information of each seat at the target location each time the seat is selected;
determining, according to the selection sequence information of each seat at the target location each time the seat is selected, a corresponding priority score of each seat each time the seat is selected, gathering the corresponding priority scores of the same seat each time the seat is selected, and determining priority information of each seat at the target location; and
storing seat information of each seat at the target location and the priority information corresponding to each seat as items of the seat information database.

7. The method according to claim 6, wherein a functional relation is established in advance, in which the selection sequence information of the seat is used as an independent variable, the priority score of the seat is used as a dependent variable, the priority score of the seat sequentially descends according to the selection sequence of the seat; the functional relation comprises a linear or a nonlinear relationship, and further comprises:
determining, according to the selection sequence information of each seat at the target location each time the seat is selected, a corresponding priority score of each seat each time the seat is selected, further comprising:
determining the functional relation and the corresponding priority score of each seat each time the seat is selected according to the selection sequence information of each seat at the target location each time the seat is selected and the functional relation.

8. The method according to claim 6 further comprising:
determining correlation between seats according to position distribution of each seat at the target location; and
correcting the priority information of each seat at the target location according to the correlation between the seats.

9. The method according to claim 6, further comprising:
determining a distribution status of each piece of selection sequence information after the corresponding selection sequence information is collected when the same seat is selected multiple times and performing priority selection for multiple pieces of selection sequence information according to the distribution status; and
determining, according to the selection sequence information of each seat at the target location each time the seat is selected, a corresponding priority score of each seat each time the seat is selected, wherein the determining of the corresponding priority score of each seat each time the seat is selected further comprises:
determining, according to the selection sequence information after a preferential selection, the corresponding priority score of each seat each time the seat is selected.

10. An apparatus for providing seat information, the apparatus comprising:
a reservation request receiving unit configured to receive a request uploaded by a client for reserving a seat at a current location;
a priority determining unit configured to query a preset seat information database and determine priority information corresponding to remaining seats at the current location, wherein the seat information database is established according to selection sequence information of each seat in a seat selection history record each time the seat is selected, and wherein information of each seat at the current location and corresponding priority information is stored in the seat information database;
a to-be-recommended seat determining unit configured to determine information of a to-be-recommended seat from the remaining seats at the current location according to the priority information corresponding to the remaining seats; and
a seat information returning unit configured to return the information of the to-be-recommended seat to the client.

11. The apparatus according to claim 10, further comprising:
a reservation quantity determining unit configured to determine a reservation quantity of seats at the current location corresponding to the current request; and
wherein the to-be-recommended seat determining unit comprises:
a to-be-recommended seat determining subunit configured to determine information of a seat having a specific relative position relationship from the remaining seats at the current location according to the priority information corresponding to the remaining seats and the reservation quantity, and use the determined information as the information of the to-be-recommended seat.

12. The apparatus according to claim 10 further comprising:
a selection result receiving unit configured to receive a result of selection of the to-be-recommended seat made by a user via the client; and
a priority updating unit configured to update priority information of a related seat in the seat information database according to a selection sequence of the seat in the selection result.

13. A computer-readable medium having stored thereon, computer-executable instructions that, if executed by a processor, cause the processor to perform a method comprising:
sending a request for reserving a seat at a current location from a client to a server so as to query a preset seat information database, determine priority information corresponding to remaining seats at the current location, determine information of a to-be-recommended seat from the remaining seats at the current location according to the priority information corresponding to the remaining seats, and return the information of the to-be-recommended seat to the client, wherein the seat information database is established according to selection sequence information of each seat in a seat selection history record each time the seat is selected, and wherein information of each seat at the current location and corresponding priority information is stored in the seat information database; and
presenting a seat recommendation according to the returned information of the to-be-recommended seat.

14. An apparatus for establishing a seat information database, the apparatus comprising:
a seat selection information collecting unit configured to collect a seat selection history record at a target location, and determining, according to the history record, selection sequence information of each seat at the target location each time the seat is selected;
a priority determining unit configured to determine, according to the selection sequence information of each seat at the target location each time the seat is selected, a corresponding priority score of each seat each time the seat is selected, gather the corresponding priority scores of the same seat each time the seat is selected, and determine priority information of each seat at the target location; and
a database storing unit configured to store seat information of each seat at the target location and the priority information corresponding to each seat as items of the seat information database.

15. The apparatus according to claim 14, wherein a functional relation is established in advance, the selection sequence information of the seat being used as an independent variable therein, the priority score of the seat being used as a dependent variable, the priority score of the seat sequentially descending according to the selection sequence of the seat; the functional relation comprising a linear or a nonlinear relationship; and
wherein the priority determining unit comprises:
a first priority determining subunit configured to determine, according to the selection sequence information of each seat at the target location each time the seat is selected and the functional relation, the corresponding priority score of each seat each time the seat is selected.

16. The apparatus according to claim 14 further comprising:
a position correlation determining unit configured to determine correlation between seats according to position distribution of each seat at the target location; and
a priority correcting unit configured to correct the priority information of each seat at the target location according to the correlation between the seats.

17. The apparatus according to claim 14 further comprising:
a seat selection information preferably selecting unit, configured to determine distribution status of each piece of selection sequence information after the corresponding selection sequence information is collected when the same seat is selected multiple times, and perform priority selection for the multiple pieces of selection sequence information according to the distribution status; and
wherein the priority determining unit comprises:
a second priority determining subunit configured to determine, according to the selection sequence information after the preferential selection, the corresponding priority score of each seat each time the seat is selected.
